(19) United States
(12) Patent Application Publication
(10) Pub. No.: US 2026/0128625 A1
(43) Pub. Date: May 7, 2026

(54) IN-WHEEL ELECTRIC MACHINES FOR ELECTRIC VEHICLES

(71) Applicant: Donut Lab Development Oü, Harju maakond (EE)

(72) Inventors: Ville Piippo, Haarajoki (FI); Tuomo Lehtimäki, Monaco (MC); Gareth Roberts, Swindon (GB); Joshua Best, Wiltshire (GB); Oliver Holt, Bristol (GB)

(21) Appl. No.: 18/939,840

(22) Filed: Nov. 7, 2024

(51) Int. Cl. H02K 1/14; B60K 7/00; H02K 1/2792; H02K 15/02; H02K 21/22

(52) U.S. Cl. CPC H02K 1/146; B60K 7/0007; H02K 1/2792; H02K 15/022; H02K 21/22

(57) ABSTRACT

In-wheel electric machines (e.g., electric motors, electric generators, etc.) for electric vehicles are disclosed. An example in-wheel electric machine includes a stator and a rotor. The stator includes a ferromagnetic core, a plurality of teeth circumferentially arranged about the ferromagnetic core, and a plurality of edgewise coils coupled to the plurality of teeth. Respective ones of the plurality of teeth extend in a radially outward direction from the ferromagnetic core and are spaced apart from one another by respective ones of a plurality of slots. Respective ones of the plurality of edgewise coils are radially loaded onto the respective ones of the plurality of teeth. The rotor is located externally relative to the stator and is configured to rotate relative to the stator. The rotor includes a plurality of permanent magnets arranged in a Halbach array.

### FIELD OF THE DISCLOSURE

This disclosure relates generally to electric machines (e.g., electric motors, electric generators, etc.) and, more specifically, to in-wheel electric machines for electric vehicles.

### BACKGROUND

Electric motors typically include a stator, a rotor, wound wire (often referred to as “windings”), and field magnets. The stator and the rotor are mechanical components. The rotor is configured to rotate relative to the stator. The stator and the rotor can be implemented in either an internal rotor configuration in which the stator circumscribes the rotor, or conversely in an external rotor configuration in which the rotor circumscribes the stator. The windings and the field magnets are electrical components. One of these components is connected to the stator, while the other is connected to the rotor. A ferromagnetic core of the stator and the windings and the field magnets form a magnetic circuit in which the field magnets generate a magnetic field that interacts with the windings. In response to electrical current supplied to the windings, the magnetic field associated with the field magnets generates torque on the rotor, which in turn causes the rotor to rotate relative to the stator. Electric motors accordingly transform electrical energy into mechanical energy. An electric generator can be constructed in a manner similar to that of the electric motor described above, but with the electric generator instead being configured to transform mechanical energy into electrical energy. An electric machine can be implemented to function and/or operate as both an electric motor and an electric generator.

Electric motors exist in many forms and varieties, and can generally be classified based on factors such as the type of power supply, the intended application, the configuration, and the output type. For example, electric motors can be powered by either direct current (DC) sources (e.g., batteries or rectifiers) or alternating current (AC) sources (e.g., power grids, generators, or inverters), can be either brushless or brushed, can be either synchronous or asynchronous, can be configured for either radial flux or axial flux, can include either permanent magnets or electromagnets, and can operate on polyphase, three-phase, two-phase, or single-phase power. Electric motors are widely used across multiple industries (e.g., automotive, medical, household, etc.) and a variety of applications including vehicles, appliances, tools, fans, blowers, turbines, compressors, pumps, etc.

Electric vehicles have risen in popularity over the past decade. Electric vehicles are typically powered by one or more electric motor(s) that draw(s) electricity from an onboard rechargeable battery. Electric vehicles exist in many forms; wheeled electric vehicles, for example, include cars, vans, trucks, motorcycles, scooters, etc. that include at least one wheel powered by an electric motor. The majority of wheeled electric vehicles include powertrains having an inboard electric motor, transmission, and driveline, all of which contribute to the mass, complexity, and losses of the propulsion system, as well as a volume penalty within the chassis of the vehicle. In some implementations of a wheeled electric vehicle, the primary components of the electric motor are integrated into and/or incorporated within the wheel itself. Such implementations are commonly referred to as “in-wheel” electric motors. A key advantage of in-wheel electric motors is the ability to eliminate many if not all of the aforementioned peripheral components and the penalties associated therewith, and also to provide significant improvement in transient performance.

An in-wheel electric motor is one form of a direct drive electric machine. The integration of electric motors into other forms of direct drive electric machines (e.g., appliances, medical devices, etc.) that do not necessarily include a wheel has also recently risen in popularity. The teachings set forth in the instant disclosure are applicable to direct drive electric machines of all types, including without limitation to in-wheel electric machines (e.g., in-wheel electric motors) for electric vehicles.

### BRIEF DESCRIPTION OF THE DRAWINGS

FIG. 1 is a side view of an example electric machine having an internal rotor configuration.

FIG. 2 is a side view of an example electric machine having an external rotor configuration.

FIG. 3 is a block diagram of an example electric vehicle including an in-wheel electric machine.

FIG. 4 is a perspective view of an example implementation of the electric vehicle of FIG. 3.

FIG. 5 is a side view of an example stator.

FIG. 6 is an enlarged view of a portion of FIG. 5.

FIG. 7 is a perspective view of an example edgewise coil.

FIG. 8 is a perspective view of the edgewise coil of FIG. 7 positioned for radial loading onto a tooth of the stator of FIG. 5.

FIG. 9 is another perspective view of the edgewise coil of FIG. 7 positioned for radial loading onto a tooth of the stator of FIG. 5.

FIG. 10 is another perspective view of the edgewise coil of FIG. 7 positioned for radial loading onto a tooth of the stator of FIG. 5.

FIG. 11 is a perspective view of a first example set of example edgewise coils that are connected together via a first connection mechanism.

FIG. 12 is a perspective view of a second example set of first example edgewise coils and second example edgewise coils that are connected together via a second connection mechanism.

FIG. 13 is a perspective view of a third example set of example edgewise coils formed from an example single wire having no connections.

FIG. 14 is a perspective view of an example chain of edgewise coils being radially loaded onto the teeth of the stator of FIG. 5.

FIG. 15 is a side cross-sectional view of an example electric machine including the stator of FIG. 5 and an example rotor.

FIG. 16 is an enlarged view of a portion of FIG. 15.

FIG. 17 illustrates a plurality of example edgewise coils arranged in an example star wiring configuration for use with the electric machine of FIGS. 15 and 16.

FIG. 18 illustrates a plurality of example edgewise coils arranged in an example delta wiring configuration for use with the electric machine of FIGS. 15 and 16.

FIG. 19 illustrates a plurality of example edgewise coils arranged in another example star wiring configuration for use with the electric machine of FIGS. 15 and 16.

FIG. 20 is a flowchart representing a first example method for assembling an electric machine.

FIG. 21 is a flowchart representing a second example method for assembling an electric machine.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Electric machines (e.g., electric motors, electric generators, etc.) are widely used across multiple industries (e.g., automotive, medical, household, etc.) and a variety of applications including vehicles, appliances, tools, fans, blowers, turbines, compressors, pumps, etc. Example electric machines disclosed herein are configured as in-wheel electric machines for electric vehicles. The disclosed electric machines can alternatively be used in other industries and/or applications that may or may not pertain to electric vehicles, and that may or may not include one or more wheel(s).

In some disclosed examples, an in-wheel electric machine includes a stator and a rotor. The stator includes a ferromagnetic core, a plurality of teeth circumferentially arranged about the ferromagnetic core, and a plurality of edgewise coils coupled to the plurality of teeth. Respective ones of the teeth extend in a radially outward direction from the ferromagnetic core and are spaced apart from one another by respective ones of a plurality of slots. Respective ones of the edgewise coils are radially loaded onto the respective ones of the teeth. The rotor is located externally relative to the stator. The rotor includes a plurality of permanent magnets arranged in a Halbach array. The rotor is configured to rotate relative to the stator.

In some disclosed examples, each tooth from among the plurality of teeth includes a pair of parallel walls extending in an axial direction of the stator. The parallel walls form a pair of opposed, axially-extending, parallel surfaces configured to enable one of the plurality of edgewise coils to be radially loaded onto one of the plurality of teeth.

In some disclosed examples, the stator includes a total of fifty-four teeth and a total of fifty-four slots, and the rotor includes a total of fifty-two poles provided by the plurality of permanent magnets. The in-wheel electric machine accordingly has a slot pole combination of fifty-four slots and fifty-two poles.

In some disclosed examples, the respective ones of the edgewise coils are coupled to one another. In some disclosed examples, connections between the respective ones of the edgewise coils are formed subsequent to the respective ones of the edgewise coils being radially loaded onto the respective ones of the teeth. In some disclosed examples, connections between the respective ones of the edgewise coils are formed prior to the respective ones of the edgewise coils being radially loaded onto the respective ones of the teeth. In some disclosed examples, the connections between the respective ones of the edgewise coils result in formation of a chain including the respective ones of the edgewise coils. The chain is configured to be radially loaded onto the respective ones of the teeth subsequent to formation of the chain.

In some disclosed examples, connections between the respective ones of the edgewise coils are formed via respective ones of a plurality of interconnect members. Each one of the interconnect members extends between two of the respective ones of the edgewise coils. Each one of the interconnect members includes a first end configured to be coupled to a connection point of a first one of the edgewise coils, and a second end configured to be coupled to a connection point of a second one of the edgewise coils located adjacent the first one of the edgewise coils. In some disclosed examples, connections between the respective ones of the edgewise coils are formed via respective ones of a plurality of extension arms integrally formed in a first subset of the respective ones of the edgewise coils. A second subset of the respective ones of the edgewise coils do not include the plurality of extension arms. Each one of the edgewise coils from among the first subset of the respective ones of the edgewise coils includes a first extension arm configured to be coupled to a connection point of a first one of the edgewise coils from among the second subset of the respective ones of the edgewise coils, and a second extension arm configured to be coupled to a connection point of a second one of the edgewise coils from among the second subset of the respective ones of the edgewise coils. The one of the edgewise coils from among the first subset of the respective ones of the edgewise coils is located between the first one and the second one of the edgewise coils from among the second subset of the respective ones of the edgewise coils.

In some disclosed examples, the respective ones of the edgewise coils are arranged as a chain formed by a continuous wire. The chain is configured to be radially loaded onto the respective ones of the teeth subsequent to formation of the chain.

Unique features of the electric machines disclosed herein give rise to exceptional performance characteristics for in-wheel electric machine applications (e.g., in-wheel electric motor applications) in which torque density is typically of paramount importance. For such applications, sufficient torque is required not only to overcome obstacles such as curbs and steep slopes at low speeds, but also to accelerate the electric vehicle quickly. In an in-wheel electric motor, the speed of the electric motor is fixed by the speed of the wheel, and the size of the electric motor is fixed by the size of the wheel within which the electric motor resides. Since power is a function of torque multiplied by speed and the speed is fixed, it becomes necessary to maximize the torque density associated with the given space of the electric motor in order to generate the power required at higher speeds. Although torque density is of prime importance, it cannot be generated in a way that sacrifices peak power and efficiency to such an extent that it negatively impacts the usability of the electric vehicle. Torque density must therefore be maximized in an optimal manner. In the interest of achieving an optimized increase in torque density, the electric motors disclosed herein include a rotor that is positioned externally relative to the stator. The external rotor configuration of the disclosed electric motors advantageously maximizes the radial distance of the acting electromagnetic force, thereby achieving the highest possible torque output (as well as the highest possible torque density) for a radial flux electric motor of a given diameter. The external rotor configuration accordingly facilitates a direct drive arrangement for in-wheel electric motor applications requiring high torques at low speeds. The external rotor configuration also facilitates fixing a wheel (e.g., including a tire) directly to the outside of the rotor, and also facilitates fixing a magnet assembly directly to the rim of the wheel without the need for additional transmission components. The external rotor configuration accordingly minimizes the number of components between the origin of motive force and a contact patch of a tire of the wheel, thereby producing enhanced transient performance that positively influences traction control and braking control associated with in-wheel electric motor applications and, more broadly, with automotive applications in general.

Traditional electric motor designs often involve complex coil winding procedures that must be performed on the stator. This process can be time-consuming, and is often prone to manufacturing inconsistencies. In contrast to such traditional electric motor designs, the disclosed electric motors include a stator having teeth that are configured to accept and/or receive pre-formed edgewise coils. This feature advantageously enables the edgewise coils to be wound and/or welded prior to the assembly of the electric motor. The pre-formed edgewise coils can advantageously be radially loaded on to the teeth of the stator during the assembly process. The external rotor configuration of the disclosed electric motors, combined with the ability to radially load pre-formed edgewise coils onto teeth of the stator, enhances manufacturing efficiency and motor performance compared with that associated with traditional electric motors having stranded concentrated windings.

Traditional electric motor designs also often dictate that the rotor of the electric motor includes a laminated magnetic steel structure (e.g., a back iron) configured to concentrate the magnetic flux associated with the rotor toward the air gap of the electric motor. The back iron has an associated mass that adds to the overall mass of the electric motor, and an associated thickness that inherently reduces the radial distance at which permanent magnets that are attached to the rotor can be located relative to an axis of rotation of the electric motor. In contrast to such traditional electric motor designs, the disclosed electric motors include a rotor having permanent magnets arranged in a Halbach array. Arranging the permanent magnets of the rotor in a Halbach array eliminates the need for a back iron. Eliminating the back iron from the rotor advantageously reduces the overall system mass, reduces wheel inertia, increases air gap flux density, and increases gravimetric torque density, thereby positively influencing the overall performance of the electric motor. For example, in the case of in-wheel electric motor applications, eliminating the back iron from the rotor enables the permanent magnets to be placed on or adjacent the rim of the wheel, which further increases the radial distance of the acting electromagnetic force. Placing the permanent magnets at a greater distance from the axis of rotation further increases the torque capability for a given electromotive force. Without the need for a back iron in the rotor, a material with improved mechanical properties can be used for the outer structure of the rotor. Elimination of the back iron accordingly allows for higher rotational speeds and stresses to be accommodated in the rotor, while also reducing the mass of the rotating components. For in-wheel electric motor applications, such capabilities positively influence the rotational inertia of the electric motor to the benefit of various dynamics (lateral acceleration/deceleration, stability, response to steering inputs, etc.) of the electric vehicle.

The disclosed electric motors also advantageously facilitate optimized slot pole combinations that allow for a strategic choice in the number of individual coils in a phase and the grouping of these coils into phase belts. In this regard, the number of phase belts is equal to the difference between the slot and pole count such that the number of slots is divisible by the number of phases and the number of poles is divisible by two. The required number of turns of per phase of the electric motor dictate the number of phase belts. The most advantageous slot pole combination provides the highest fundamental winding factor (directly influencing torque output), and the lowest number of required phase belts for assembly. With regard to the disclosed electric motors, the inclusion of a stator having edgewise coils and a rotor having permanent magnets arranged in a Halbach array facilitates a slot pole combination of fifty-four slots and fifty-two poles. This particular slot pole combination advantageously groups the coils into the lowest (e.g., minimal) number of required phase belts for ease of assembly. For example, the slot pole combination of fifty-four slots and fifty-two poles associated with the disclosed electric motors advantageously requires only two phase belts for assembly. Other combinations of slots, poles, and phase belts are also feasible.

The above-identified features as well as other advantageous features of example in-wheel electric machines for electric vehicles are further described below in connection with the figures of the application.

As used herein, the term “electric machine(s)” encompasses electric motor(s) configured to transform electrical energy into mechanical energy, and further encompasses electric generator(s) configured to transform mechanical energy into electrical energy.

As used herein in a mechanical context, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part. As used herein in an electrical and/or computing context, the term “configured” means arranged, structured, and/or programmed. For example, in the context of processor circuitry configured to perform a specified operation, the processor circuitry is arranged, structured, and/or programmed (e.g., based on machine-readable instructions) to perform the specified operation.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein, the term “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a”(or “an”), “one or more,”and “at least one”are used interchangeably herein.

Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

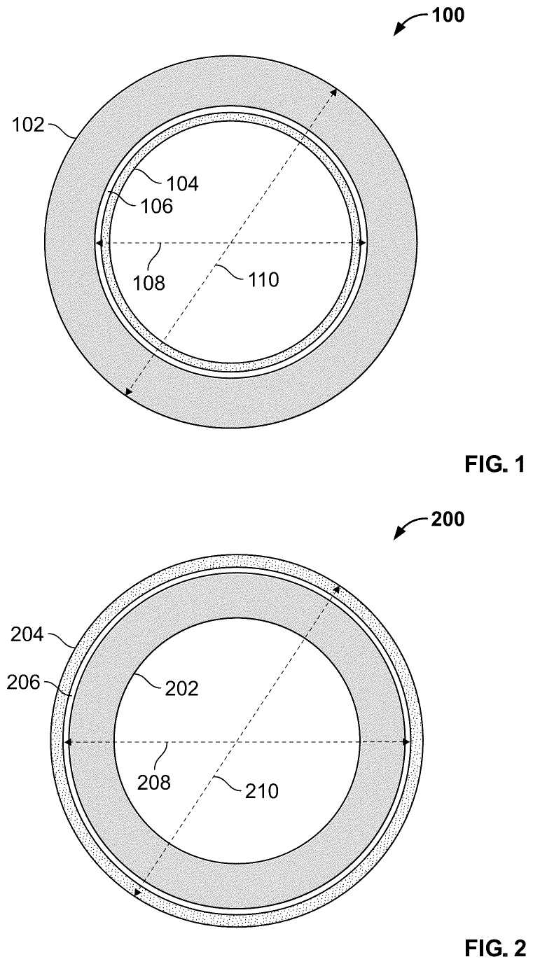

FIG. 1 is a side view of an example electric machine 100 having an internal rotor configuration. In some examples, the electric machine 100 of FIG. 1 can be implemented by and/or function as an electric motor configured to convert electrical energy into mechanical energy. In other examples, the electric machine 100 of FIG. 1 can be implemented by and/or function as an electric generator configured to convert mechanical energy into electrical energy. In some examples, the electric machine 100 of FIG. 1 can be implemented in a manner that enables the electric machine 100 to function (e.g., selectively function) as either an electric motor or as an electric generator. In the illustrated example of FIG. 1, the electric machine 100 includes an example stator 102 and an example rotor 104, with the stator 102 and the rotor 104 being arranged such that the stator 102 circumscribes the rotor 104. The rotor 104 of the electric machine 100 of FIG. 1 is configured to rotate relative to the stator 102. As shown in FIG. 1, the radial thickness of the stator 102 is substantially greater than the radial thickness of the rotor 104. The stator 102 and the rotor 104 are separated by an example air gap 106 having an example diameter 108 that generally corresponds to the inner diameter of the stator 102. The presence of the air gap 106 facilitates rotation of the rotor 104 relative to the stator 102.

FIG. 2 is a side view of an example electric machine 200 having an external rotor configuration. In some examples, the electric machine 200 of FIG. 2 can be implemented by and/or function as an electric motor configured to convert electrical energy into mechanical energy. In other examples, the electric machine 200 of FIG. 2 can be implemented by and/or function as an electric generator configured to convert mechanical energy into electrical energy. In some examples, the electric machine 200 of FIG. 2 can be implemented in a manner that enables the electric machine 200 to function (e.g., selectively function) as either an electric motor or as an electric generator. In the illustrated example of FIG. 2, the electric machine 200 includes an example stator 202 and an example rotor 204, with the stator 202 and the rotor 204 being arranged such that the rotor 204 circumscribes the stator 202. The rotor 204 of the electric machine 200 of FIG. 2 is configured to rotate relative to the stator 202. As shown in FIG. 2, the radial thickness of the stator 202 is substantially greater than the radial thickness of the rotor 204. The stator 202 and the rotor 204 are separated by an example air gap 206 having an example diameter 208 that generally corresponds to the inner diameter of the rotor 204. The presence of the air gap 206 facilitates rotation of the rotor 204 relative to the stator 202.

In the illustrated examples shown in FIGS. 1 and 2, an example overall diameter 210 of the electric machine 200 of FIG. 2 (e.g., measured as the outer diameter of the rotor 204) matches and/or is substantially the same as an example overall diameter 110 of the electric machine 100 of FIG. 1 (e.g., measured as the outer diameter of the stator 102). Notably, however, the diameter 208 of the air gap 206 of the electric machine 200 of FIG. 2 is substantially greater than the diameter 108 of the air gap 106 of the electric machine 100 of FIG. 1. Relative to the diameter 108 of the air gap 106 associated with the internal rotor configuration of the electric machine 100 of FIG. 1, the increased (e.g., maximized) diameter 208 of the air gap 206 associated with the external rotor configuration of the electric machine 200 of FIG. 2 advantageously increases the volumetric torque density associated with the electric machine 200 relative to that of the electric machine 100 of FIG. 1. As a result, the electric machine 200 of FIG. 2 is advantageously able to produce more torque in the package space (e.g., the overall volume of the machine) of the electric machine 200 in comparison to the torque which might be produced in the similarly-sized (e.g., identically-sized) package space (e.g., the overall volume of the machine) of the electric machine 100 of FIG. 1. Electric machines having an external rotor configuration of the type shown in association with the electric machine 200 of FIG. 2 can accordingly be beneficial for applications requiring the generation of high levels of torque.

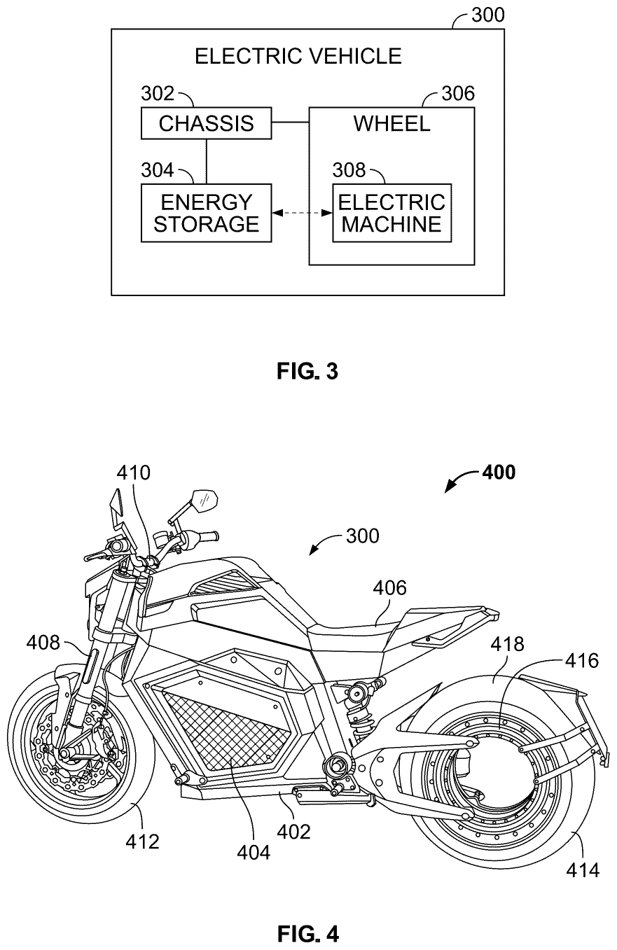

FIG. 3 is a block diagram of an example electric vehicle 300 including an in-wheel electric machine. While the electric vehicle 300 of FIG. 3 is illustrated as having a single in-wheel electric machine associated with a single electrically-driven wheel, it is to be understood that the electric vehicle 300 can alternatively include a different number (e.g., two, three, four, etc.) of in-wheel electric machines associated with a different number (e.g., two, three, four, etc.) of electrically-driven wheels. It is also to be understood that the electric vehicle 300 of FIG. 3 can include one or more wheel(s) that is/are not electrically driven in addition to the one or more electrically-driven wheel(s) that is/are associated with the in-wheel electric machine(s) of the electric vehicle 300. For example, when the electric vehicle 300 of FIG. 3 is implemented as a two-wheeled electric motorcycle, the electric vehicle 300 may include a rear wheel that incorporates an in-wheel electric machine, and a front wheel that does not incorporate an in-wheel electric machine. As another example, when the electric vehicle 300 of FIG. 3 is implemented as a four-wheeled electric automobile, the electric vehicle 300 may include two rear wheels, with each of the rear wheels incorporating an in-wheel electric machine, and two front wheels, with neither of the front wheels incorporating an in-wheel electric machine. Aside from requiring at least one in-wheel electric machine (i.e., one electric machine incorporated into one wheel), the electric vehicle 300 of FIG. 3 is not otherwise limited to any particular combination and/or configuration with regard to the number(s), type(s), and/or arrangement(s) of the electric machine(s), the wheel(s), and/or any other component(s) that may form part of the electric vehicle 300.

In the illustrated example of FIG. 3, the electric vehicle 300 includes an example chassis 302, an example energy storage 304, an example wheel 306, and an example electric machine 308. The chassis 302 of FIG. 3 is a structural framework configured to support and/or carry one or more other structural component(s) of the electric vehicle 300. For example, the chassis 302 can be implemented as a frame configured to carry and/or support the energy storage 304 and/or the wheel 306 of the electric vehicle 300. The specific size, shape, and/or configuration of the chassis 302 will vary depending upon the intended application. For example, the chassis 302 may have a first configuration when the electric vehicle 300 of FIG. 3 is implemented as a two-wheeled electric motorcycle, and a second, different configuration when the electric vehicle 300 is implemented as a four-wheeled electric automobile. The energy storage 304 of FIG. 3 is mechanically coupled to (e.g., supported and/or carried by) the chassis 302 of the electric vehicle 300 and operatively coupled to (e.g., in electrical communication with) the electric machine 308 of the electric vehicle 300. The energy storage 304 is configured to transfer energy to the electric machine 308, and/or to receive energy from the electric machine 308. For example, in implementations in which the electric machine 308 is implemented by and/or functions as an electric motor, the energy storage 304 transfers electrical energy to the electric motor, which thereafter converts the electrical energy into mechanical energy. Conversely, in implementations in which the electric machine is implemented by and/or functions as an electric generator, the electric generator converts mechanical energy into electrical energy, and thereafter transfers the electrical energy to the energy storage 304. The energy storage 304 of FIG. 3 can be implemented as either a DC power source with an inverter to convert DC power to AC power, or as an AC power source.

The wheel 306 of FIG. 3 is mechanically coupled to (e.g., supported and/or carried by) the chassis 302 of the electric vehicle 300. The specific size, shape, and/or configuration of the wheel 306 will vary depending upon the intended application. For example, the wheel 306 may have a first configuration when the electric vehicle 300 of FIG. 3 is implemented as a two-wheeled electric motorcycle, and a second, different configuration when the electric vehicle 300 is implemented as a four-wheeled electric automobile. In the illustrated example of FIG. 3, the wheel 306 incorporates and/or otherwise includes the electric machine 308 such that the electric machine 308 constitutes an in-wheel electric machine. The electric machine 308 of FIG. 3 is mechanically coupled to (e.g., supported and/or carried by) the chassis 302 of the electric vehicle 300. The specific size, shape, and/or configuration of the electric machine 308 will vary depending upon the intended application. For example, the electric machine 308 may have a first configuration when the electric vehicle 300 of FIG. 3 is implemented as a two-wheeled electric motorcycle, and a second, different configuration when the electric vehicle 300 is implemented as a four-wheeled electric automobile. In the illustrated example of FIG. 3, the electric machine 308 is preferably implemented by and/or as an electric machine having an outer rotor configuration (e.g., the electric machine 200 of FIG. 2 described above) in which a rotor of the electric machine 308 circumscribes a stator of the electric machine 308, with the rotor being configured to rotate relative to the stator. In such an implementation, the wheel 306 includes a tire that circumscribes and is mechanically coupled to the rotor of the electric machine 308 such that rotation of the rotor causes a corresponding rotation of the tire.

FIG. 4 is a perspective view of an example implementation of the electric vehicle 300 of FIG. 3. As shown in FIG. 4, the electric vehicle 300 is implemented as an electric motorcycle 400. An example chassis 402 of the electric motorcycle 400 (e.g., corresponding to the chassis 302 of FIG. 3) is configured to support and/or carry numerous structural component(s) of the electric motorcycle 400. For example, as shown in FIG. 4, the chassis 402 supports and/or carries an energy storage (e.g., a battery) that is concealed and/or otherwise located behind and/or within an example protective housing 404 associated with the chassis 402. The chassis 402 further supports and/or carries an example seat 406 of the electric motorcycle 400. The chassis 402 further supports and/or carries example forks 408 that support and/or carry example handlebars 410 and/or an example front wheel 412 of the electric motorcycle 400. The chassis 402 further supports and/or carries an example rear wheel 414 (e.g., corresponding to the wheel 306 of FIG. 3) that includes an example electric machine 416 (e.g., corresponding to the electric machine 308 of FIG. 3) of the electric motorcycle 400. The rear wheel 414 of the electric motorcycle 400 of FIG. 4 accordingly includes an in-wheel electric machine, while the front wheel 412 of the electric motorcycle 400 of FIG. 4 lacks any such in-wheel electric machine.

In the illustrated example of FIG. 4, the electric machine 416 is implemented in a manner that enables the electric machine 416 to function (e.g., selectively function) as either an electric motor or as an electric generator. The electric machine 416 of the electric motorcycle 400 of FIG. 4 has an outer rotor configuration in which a rotor of the electric machine 416 circumscribes a stator of the electric machine 416, with the rotor being configured to rotate relative to the stator. The rear wheel 414 of the electric motorcycle 400 includes an example tire 418 that circumscribes and is mechanically coupled to the rotor of the electric machine 416 such that rotation of the rotor causes a corresponding rotation of the tire 418. The electric motorcycle 400 of FIG. 4 illustrates one of many possible example implementations of the electric vehicle 300 of FIG. 3. As discussed above, numerous other example implementations of the electric vehicle 300 of FIG. 3 are possible, are contemplated, and/or are within the scope of the inventions disclosed herein.

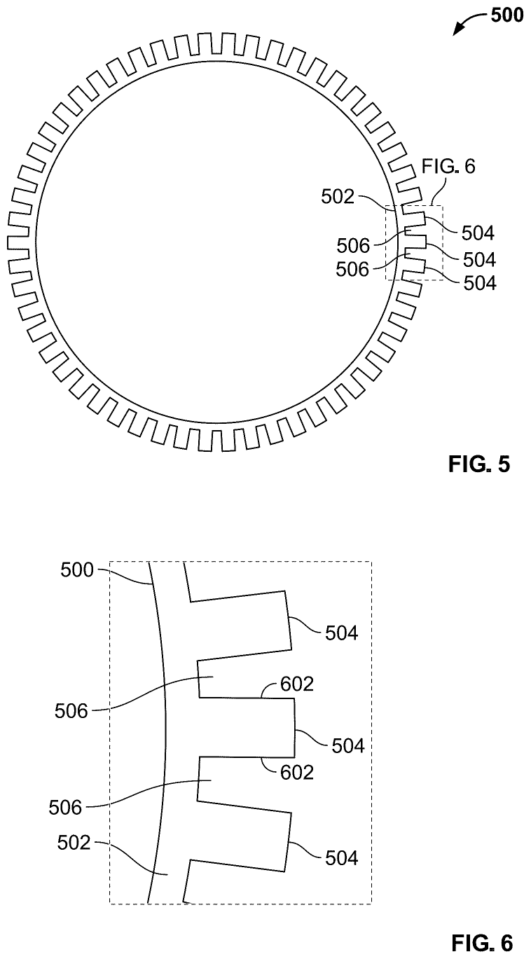

FIG. 5 is a side view of an example stator 500. FIG. 6 is an enlarged view of a portion of FIG. 5. The stator 500 of FIGS. 5 and 6 is configured to be incorporated into and/or otherwise included in an electric machine having an external rotor configuration. The stator 500 of FIGS. 5 and 6 can accordingly be incorporated into and/or otherwise included in an in-wheel electric machine of an electric vehicle (e.g., the electric machine 308 of the wheel 306 of the electric vehicle 300 of FIG. 3, the electric machine 416 of the rear wheel 414 of the electric motorcycle 400 of FIG. 4, etc.). The stator 500 of FIGS. 5 and 6 can alternatively be incorporated into and/or otherwise included in other types of external rotor electric machine applications, many of which may be intended for use with devices and/or systems other than electric vehicles (e.g., appliances, tools, assembly lines, etc.).

In the illustrated example of FIGS. 5 and 6, the stator 500 includes an example annular (e.g., ring-shaped) ferromagnetic core 502. The stator 500 of FIGS. 5 and 6 further includes a plurality of example teeth 504 coupled to and circumferentially arranged about the outside of the ferromagnetic core 502. In this regard, each tooth 504 of the stator 500 extends from the ferromagnetic core 502 in a radially outward direction, with respective ones (e.g., neighboring ones) of the plurality of teeth 504 being spaced apart from one another by a corresponding plurality of example slots 506. As shown in FIGS. 5 and 6, each tooth 504 of the stator 500 has a rectangular cross-sectional shape defined in part by a pair of example parallel walls 602 that extend in an axial direction. The parallel walls 602 of each tooth 504 form a pair of opposed, axially-extending, parallel surfaces onto which a winding (e.g., a pre-formed edgewise coil) is to be radially loaded, as further described herein.

In the illustrated example of FIGS. 5 and 6, the stator 500 includes a total of fifty-four teeth 504 and a corresponding total of fifty-four slots 506 located between neighboring ones of the teeth 504. The aforementioned number (i.e., fifty-four) of teeth 504 and slots 506 represents a preferred number of teeth 504 and slots 506 for electric machine implementations that incorporate and/or otherwise include two belts, three phases per belt, and nine slots 506 per phase (e.g., 2 belts×3 phases×9 slots=54 slots), as further described herein. In other examples, the stator 500 can instead include a different total number of teeth 504 and/or a different corresponding total number of slots 506. The preferred number of teeth and/or slots will ultimately be determined based on the specific configuration (e.g., wheel size, power, torque, voltage, belt number, etc.) of the electric machine. Different configurations of electric machines can accordingly have different preferred numbers of teeth 504 and slots 506 relative to the example stator 500 of FIGS. 5 and 6.

Windings can be added around the teeth 504 and/or within the slots 506 of the stator 500 of FIGS. 5 and 6. In some examples, the windings can be formed from wire having a generally circular (e.g., round) cross-sectional area. In other examples, the windings can instead be formed from wire having a rectangular cross-sectional area. In a traditional rectangular wire construction, a hairpin architecture is used. When a hairpin architecture is implemented, each turn of the wire needs to be joined together, which is usually accomplished by stripping away insulation and then welding respective ones of the turns. Implementing a hairpin architecture accordingly requires a large number of welds, which in turn necessitates the use of expensive laser welding and stripping technologies that are automated by complex vision systems. The large number of welds required when implementing a hairpin architecture give rise to a correspondingly large number of potential and/or possible points of failure associated with the resultant winding. Furthermore, hairpin architectures typically have a large end winding (e.g., the portion of the wire that is necessary to connect the turns of the wire together at the ends of the electric machine). In addition to occupying substantial packaging space in the axial direction of the electric machine, the end winding also fails to make any meaningful contribution to the generation of torque in the electric machine. These features of a hairpin architecture are generally disadvantageous for electric machine implementations, and particularly so for electric machine implementations (e.g., electric motor implementations) in which high torque generation is necessary and packaging space is limited. Hairpin architectures are accordingly unsuitable for use in and/or with in-wheel electric machines (e.g., in-wheel electric motors).

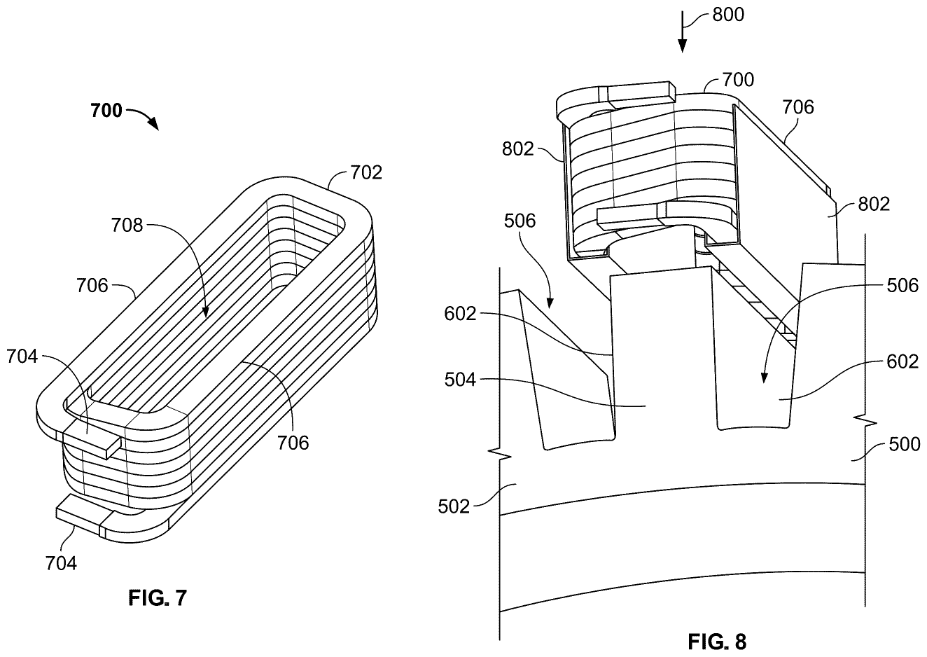

In a more unconventional rectangular wire construction, the rectangular wire is bent and/or wound along the short side (e.g., as opposed to the long side) of the rectangular cross-sectional area of the wire. This winding approach is commonly referred to as edgewise winding, with the resultant winding and/or coil of wire being referred to as an edgewise coil. FIG. 7 is a perspective view of an example edgewise coil 700. In the illustrated example of FIG. 7, the edgewise coil 700 includes an example end winding 702, two example connection points 704 located opposite the end winding 702, and an example torque-generating region 706 located between the end winding 702 on the one hand and the connection points 704 on the other hand. The edgewise coil 700 further includes an example opening 708 extending centrally through the edgewise coil 700. The edgewise coil 700 of FIG. 7 is formed by pre-winding rectangular wire along the short side (e.g., as opposed to the long side) of the rectangular cross-sectional area of the wire into the coiled shape and/or coiled configuration shown in FIG. 7, which then enables the formed, pre-wound rectangular wire that constitutes the edgewise coil 700 to be radially loaded onto a tooth of a stator (e.g., one of the teeth 504 of the stator 500 of FIG. 5) and/or into a slot of a stator (e.g., one of the slots 506 of the stator 500 of FIG. 5), as further described herein. In the illustrated example of FIG. 7, the edgewise coil 700 includes eight layers, commonly known as turns, of wound and/or coiled rectangular wire. In other examples, the edgewise coil 700 can instead include a different number (e.g., four, six, ten, twelve, etc.) of layers of wound and/or coiled rectangular wire. The edgewise coil 700 of FIG. 7 is advantageous over other winding approaches and/or other wire types in that the turns of the edgewise coil 700 do not need to be welded, and the end winding 702 of the edgewise coil 700 is very compact.

Edgewise coils such as the edgewise coil 700 of FIG. 7 include several features that are generally advantageous for electric machine implementations, and particularly so for electric machine implementations (e.g., electric motor implementations) in which high torque generation is necessary and packaging space is limited. As one example, edgewise coils require a lower number of welds per turn in comparison to the number of welds per turn required by a hairpin architecture. Reducing the number of required welds advantageously reduces the number of potential failure points associated with the electric machine. As another example, the end windings of an edgewise coil are advantageously shorter and/or more compact than the end windings of a hairpin architecture. Reducing the size of the end windings advantageously improves the spatial packaging of the electric machine. As another example, the rectangular wire from which an edgewise coil is formed can be packed more tightly into the slots of a stator in comparison to a coil formed by a round wire, thereby increasing the amount of copper in the same space. This spatial benefit leads to a higher slot fill factor. The increased copper content within the slots of the stator advantageously allows for more current to flow, thereby resulting in higher torque and power outputs for the electric machine. As another example, the rectangular wire from which an edgewise coil is formed results in smaller gaps and larger contacting surface areas between the windings of each edgewise coil in comparison to the corresponding sizes of the gaps and contacting surface areas associated with the windings of a coil formed from round wire, thereby improving the heat dissipation of the electric machine. The improved heat dissipation associated with the edgewise coils advantageously prevents the formation of excessive heat that can otherwise reduce continuous torque performance and shorten the lifespan of the electric machine. The improved heat dissipation associated with the edgewise coils also helps to maintain lower operating temperatures and improve the overall efficiency of the electric machine. As another example, the rectangular wire from which an edgewise coil is formed provides lower electrical resistance in comparison to a coil formed from a round wire of the same size. The reduced electrical resistance translates into reduced copper losses (e.g., reduce I²R losses), thereby improving the overall efficiency of the electric machine. As another example, the combination of a higher slot fill factor and reduced copper losses associated with the rectangular wire from which an edgewise coil is formed provides for a higher power density associated with the electric machine, meaning that more power can be generated from an electric machine of the same size, or that a smaller electric machine can be used to achieve the same power output. In view of the aforementioned manufacturing, packaging, and performance benefits, edgewise coils are desirable for use in and/or with in-wheel electric machines (e.g., in-wheel electric motors).

FIG. 8 is a perspective view of the edgewise coil 700 of FIG. 7 positioned for radial loading onto a tooth 504 of the stator 500 of FIG. 5. As shown in FIG. 8, a tooth 504 of the stator 500 has a rectangular cross-sectional shape defined in part by a pair of parallel walls 602 that extend in an axial direction. The parallel walls 602 of the tooth 504 form a pair of opposed, axially-extending, parallel surfaces that facilitate loading the edgewise coil 700 in an example radial direction 800 onto the tooth 504 of the stator 500. As shown in FIG. 8, the opening 708 formed in the edgewise coil 700 has a size and shape that complements the rectangular cross-sectional shape of the tooth 504 of the stator 500 such that the parallel walls 602 of the tooth 504 guide the edgewise coil 700 onto the tooth 504 as the edgewise coil 700 is moved in the radial direction 800 onto the tooth 504 and toward the ferromagnetic core 502 of the stator 500. As the edgewise coil 700 is radially loaded onto the tooth 504, one side of the torque-generating region 706 of the edgewise coil 700 is received within a first one of the slots 506 of the stator 500 located adjacent a first one of the parallel walls 602 of the tooth 504, and the other side of the torque-generating region 706 of the edgewise coil 700 is received within a second one of the slots 506 of the stator 500 located adjacent a second one of the parallel walls 602 of the tooth 504. Upon being radially loaded onto the tooth 504 of the stator 500, the edgewise coil 700 thereafter circumscribes the tooth 504 of the stator 500.

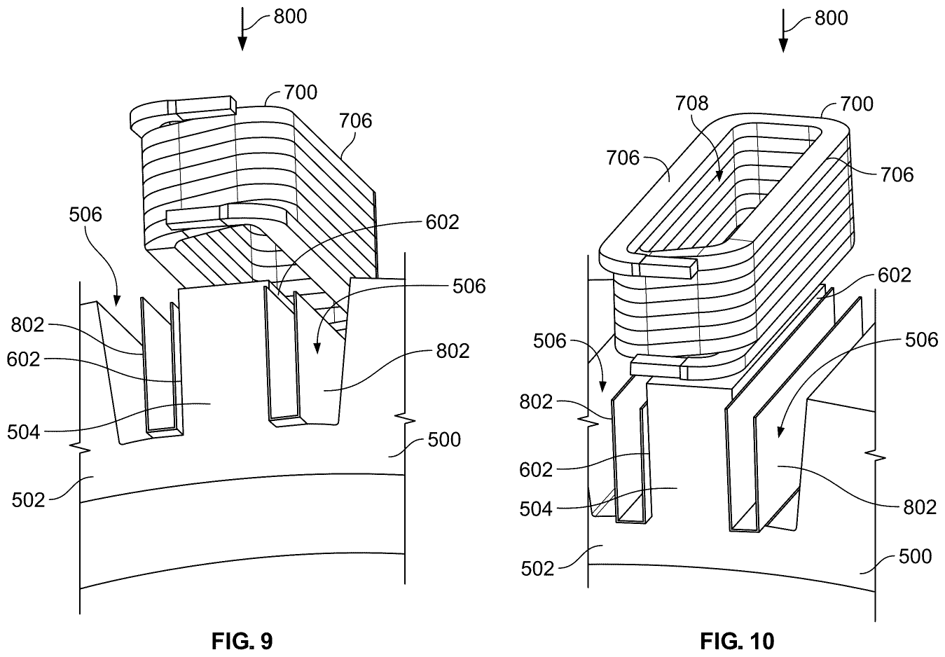

In some examples, one or more layer(s) of insulation are located and/or positioned between the tooth 504 of the stator 500 and the edgewise coil 700 prior to and/or in conjunction with radially loading the edgewise coil 700 onto the tooth 504. The insulation can take many forms (e.g., wire enamel, potting, slot liners, etc.), but is preferably implemented as a plurality of slot liners. In some examples, the insulation can be coupled and/or otherwise applied to (e.g., at least partially wrapped around) the edgewise coil 700 prior to the edgewise coil 700 being radially loaded onto the tooth 504 of the stator 500. For example, as shown in FIG. 8, a pair of example slot liners 802 are applied (e.g., radially applied) to corresponding ones of the torque-generating regions 706 of the edgewise coil 700 prior to the edgewise coil 700 being radially loaded onto the tooth 504 of the stator 500. In such an example, the slot liners 802 applied to the edgewise coil 700 will be radially loaded into the corresponding slots 506 bordering the tooth 504 of the stator 500 concurrently with the edgewise coil 700 being radially loaded onto the tooth 504. In other examples, the insulation can instead be coupled and/or otherwise applied to (e.g., inserted into) the slots 506 bordering the tooth 504 of the stator 500 prior to the edgewise coil 700 being radially loaded onto the tooth 504. For example, as shown in FIGS. 9 and 10, a pair of example slot liners 802 are applied (e.g., radially or axially applied) to corresponding ones of the slots 506 bordering the tooth 504 of the stator 500 prior to the edgewise coil 700 being radially loaded onto the tooth 504. In such an example, the slot liners 802 will receive corresponding ones of the torque-generating regions 706 of the edgewise coil 700 concurrently with the edgewise coil 700 being radially loaded onto the tooth 504 of the stator 500. In each of the examples shown in FIGS. 8-10, radially loading the edgewise coil 700 onto the tooth 504 of the stator 500 results in the slot liners 802 being located and/or positioned between the edgewise coil 700 and tooth 504.

In some examples, the process of loading the edgewise coil 700 in the radial direction 800 onto the tooth 504 of the stator 500 is performed manually (e.g., by a human). In other examples, the process of loading the edgewise coil 700 in the radial direction 800 onto the tooth 504 of the stator 500 can instead be assisted by a machine (e.g., a robotic assist). In still other examples, the process of loading the edgewise coil 700 in the radial direction 800 onto the tooth 504 of the stator 500 can instead be fully automated, and/or can be performed without human interaction and/or guidance. While the examples of FIGS. 8-10 describe the process of radially loading a single edgewise coil 700 onto a single tooth 504 of the stator 500, it is to be understood that additional instances of the edgewise coil 700 can be radially loaded onto additional ones of the teeth 504 of the stator 500 in a manner that is substantially identical to that described above.

A plurality of individual edgewise coils (e.g., such as the edgewise coil 700 of FIG. 7) must be coupled, connected, linked, and/or otherwise joined together when forming an electric machine. In some examples, respective ones of a plurality of edgewise coils can be coupled and/or connected together subsequent to the respective ones of the plurality of edgewise coils being radially loaded onto corresponding respective ones of a plurality of teeth of a stator. In such examples, a chain of connected edgewise coils formed by the respective ones of the edgewise coils does not exist until after the respective ones of the edgewise coils have already been radially loaded onto the teeth of the stator. In other examples, respective ones of a plurality of edgewise coils can instead be coupled and/or connected together prior to the respective ones of the plurality of edgewise coils being radially loaded onto corresponding respective ones of a plurality of teeth of a stator. In such other examples, a chain of connected edgewise coils formed by the respective ones of the edgewise coils exists prior to the respective ones of the edgewise coils being radially loaded onto the teeth of the stator.

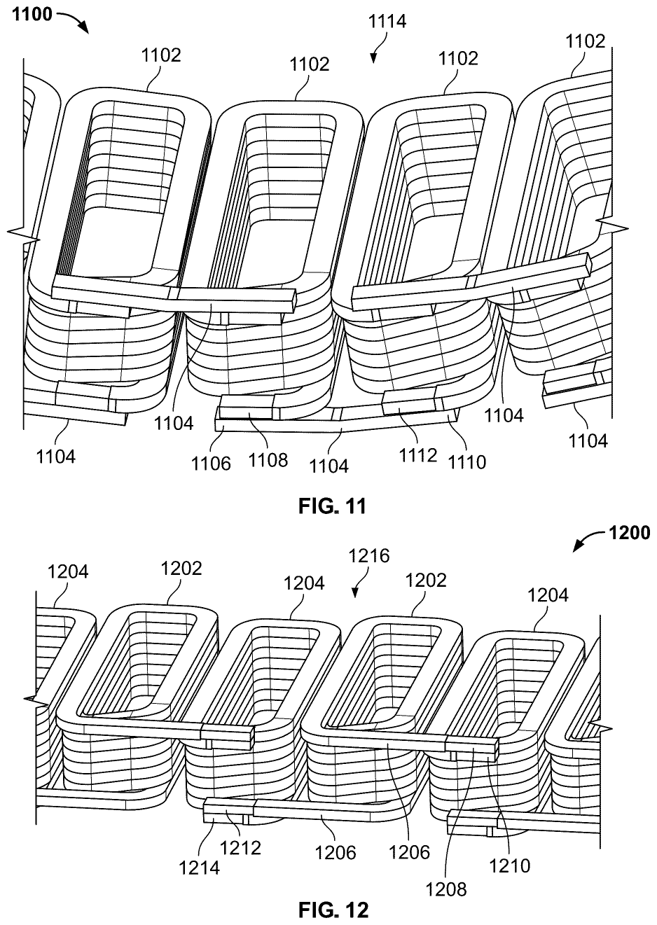

Connections between individual edgewise coils (e.g., such as the edgewise coil 700 of FIG. 7) of an electric machine (e.g., an electric motor) can be formed in numerous ways. For example, FIG. 11 is a perspective view of a first example set 1100 of example edgewise coils 1102 that are connected together via a first connection mechanism. In the illustrated example of FIG. 11, connections between respective ones of the edgewise coils 1102 are formed via respective ones of a plurality of example interconnect members 1104. Each one of the interconnect members 1104 extends between two of the respective ones of the edgewise coils 1102. Each one of the interconnect members 1104 includes an example first end 1106 configured to be coupled (e.g., welded, crimped, soldered, etc.) to an example connection point 1108 of a first one of the edgewise coils 1102, and an example second end 1110 configured to be coupled (e.g., welded, crimped, soldered, etc.) to an example connection point 1112 of a second one of the edgewise coils 1102 located adjacent the first one of the edgewise coils 1102. Each one of the interconnect members 1104 can be fabricated and/or constructed from a flexible form of copper (e.g., a braided construction) to increase the ease by which the connections between the interconnect members 1104 and the edgewise coils 1102 are formed.

In some examples, the respective ones of the edgewise coils 1102 of FIG. 11 can be coupled and/or connected together via the respective ones of the interconnect members 1104 to form an example chain 1114 prior to the respective ones of the edgewise coils 1102 being radially loaded onto corresponding respective ones of a plurality of teeth of a stator. In such examples, the chain 1114 of connected edgewise coils formed by the respective ones of the edgewise coils 1102 exists prior to the respective ones of the edgewise coils 1102 being radially loaded onto the teeth of the stator. In other examples, the respective ones of the edgewise coils 1102 of FIG. 11 can instead be coupled and/or connected together via the respective ones of the interconnect members 1104 to form the chain 1114 subsequent to the respective ones of the edgewise coils 1102 being radially loaded onto corresponding respective ones of a plurality of teeth of a stator. In such examples, the chain 1114 of connected edgewise coils formed by the respective ones of the edgewise coils 1102 does not exist until after the respective ones of the edgewise coils 1102 have already been radially loaded onto the teeth of the stator.

As another example, FIG. 12 is a perspective view of a second example set 1200 of first example edgewise coils 1202 and second example edgewise coils 1204 that are connected together via a second connection mechanism. As shown in FIG. 12, respective ones of the first edgewise coils 1202 are interleaved relative to respective ones of the second edgewise coils 1204 to form an alternating pattern of the first edgewise coils 1202 and the second edgewise coils 1204. Thus, each one of the first edgewise coils 1202 is to be located between a pair of the second edgewise coils 1204, and each one of the second edgewise coils 1204 is to be located between a pair of the first edgewise coils 1202. In the illustrated example of FIG. 12, connections between the respective ones of the first edgewise coils 1202 and the respective ones of the second edgewise coils 1204 are formed via respective ones of a plurality of example extension arms 1206 integrally formed in the respective ones of the first edgewise coils 1202.

The respective ones of the second edgewise coils 1204, on the other hand, do not include any such extension arms 1206. Each one of the first edgewise coils 1202 includes an example first extension arm 1208 configured to be coupled (e.g., welded, crimped, soldered, etc.) to an example connection point 1210 of a first one of the second edgewise coils 1204, and an example second extension arm 1212 configured to be coupled (e.g., welded, crimped, soldered, etc.) to an example connection point 1214 of a second one of the second edgewise coils 1204. In comparison to forming connections via the interconnect members 1104 shown in FIG. 11 and described above, forming connections via the extension arms 1206 shown in FIG. 12 advantageously reduces the number of required welds by half (e.g., fifty percent).

In some examples, the respective ones of the first edgewise coils 1202 and the respective ones of the second edgewise coils 1204 of FIG. 12 can be coupled and/or connected together via the respective ones of the extension arms 1206 to form an example chain 1216 prior to the respective ones of the first edgewise coils 1202 and the respective ones of the second edgewise coils 1204 being radially loaded onto corresponding respective ones of a plurality of teeth of a stator. In such examples, the chain 1216 of connected edgewise coils formed by the respective ones of the first edgewise coils 1202 and the respective ones of the second edgewise coils 1204 exists prior to the respective ones of the first edgewise coils 1202 and the respective ones of the second edgewise coils 1204 being radially loaded onto the teeth of the stator. In other examples, the respective ones of the first edgewise coils 1202 and the respective ones of the second edgewise coils 1204 of FIG. 12 can instead be coupled and/or connected together via the respective ones of the extension arms 1206 to form the chain 1216 subsequent to the respective ones of the first edgewise coils 1202 and the respective ones of the second edgewise coils 1204 being radially loaded onto corresponding respective ones of a plurality of teeth of a stator. In such examples, the chain 1216 of connected edgewise coils formed by the respective ones of the first edgewise coils 1202 and the respective ones of the second edgewise coils 1204 does not exist until after the respective ones of the first edgewise coils 1202 and the respective ones of the second edgewise coils 1204 have already been radially loaded onto the teeth of the stator.

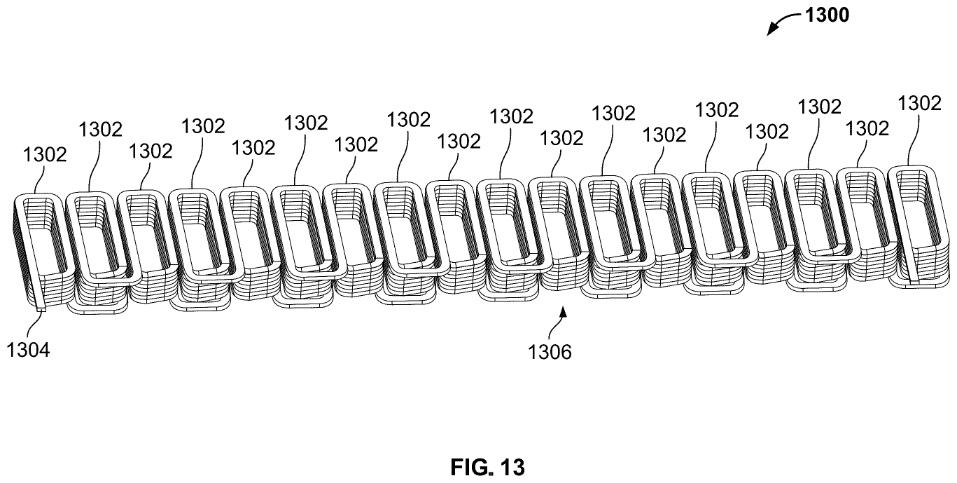

As still another example, FIG. 13 is a perspective view of a third example set 1300 of example edgewise coils 1302 formed from an example single wire 1304 (e.g., a continuous, one-piece wire). In comparison to forming connections via the interconnect members 1104 shown in FIG. 11 and described above, and/or forming connections via the extension arms 1206 shown in FIG. 12 and described above, the connection-free, single wire approach minimizes (e.g., reduces to zero or near zero) the number of required welds. In the illustrated example of FIG. 13, the respective ones of the edgewise coils 1302 are formed into an example chain 1306 prior to the respective ones of the edgewise coils 1302 being radially loaded onto corresponding respective ones of a plurality of teeth of a stator. The chain 1306 of edgewise coils formed by the respective ones of the edgewise coils 1302 accordingly exists prior to the respective ones of the edgewise coils 1302 being radially loaded onto the teeth of the stator.

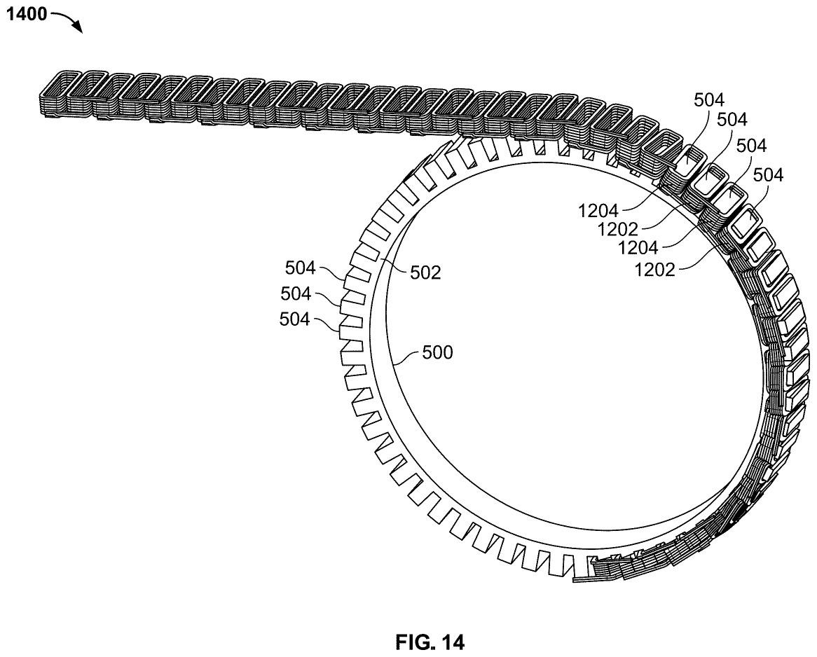

FIG. 14 is a perspective view of an example chain 1400 of edgewise coils being radially loaded onto the teeth 504 of the stator 500 of FIG. 5, similar to the manner by which a chain is radially loaded onto a sprocket. In the illustrated example of FIG. 14, the chain 1400 corresponds to and/or is implemented by the chain 1216 of FIG. 12 described above, which includes respective ones of the first edgewise coils 1202 interleaved relative to respective ones of the second edgewise coils 1204 to form an alternating pattern of the first edgewise coils 1202 and the second edgewise coils 1204. Thus, each one of the first edgewise coils 1202 is located between a pair of the second edgewise coils 1204, and each one of the second edgewise coils 1204 is located between a pair of the first edgewise coils 1202. In other examples, the chain 1400 of FIG. 14 can instead correspond to and/or be implemented by the chain 1114 of FIG. 11 described above, which includes respective ones of the edgewise coils 1102 connected by corresponding respective ones of the interconnect members 1104. In still other examples, the chain 1400 of FIG. 14 can instead correspond to and/or be implemented by the chain 1306 of FIG. 13 described above, which includes respective ones of the edgewise coils 1302 formed by a single wire 1304 (e.g., a continuous, one-piece wire).

In the illustrated example of FIG. 14, the respective ones of the first edgewise coils 1202 and the respective ones of the second edgewise coils 1204 have been coupled and/or connected together to form the chain 1400 prior to the respective ones of the first edgewise coils 1202 and the respective ones of the second edgewise coils 1204 being radially loaded onto corresponding respective ones of the teeth 504 of teeth the stator 500. The chain 1400 of connected edgewise coils formed by the respective ones of the first edgewise coils 1202 and the respective ones of the second edgewise coils 1204 accordingly exists prior to the respective ones of the first edgewise coils 1202 and the respective ones of the second edgewise coils 1204 being radially loaded onto the teeth 504 of the stator 500. As the edgewise coils of the chain 1400 of FIG. 14 do not need to be wound or welded in situ on the teeth 504 of the stator 500, this configuration advantageously facilitates an automated stator assembly process with a relatively inexpensive, simple, and flexible manufacturing line.

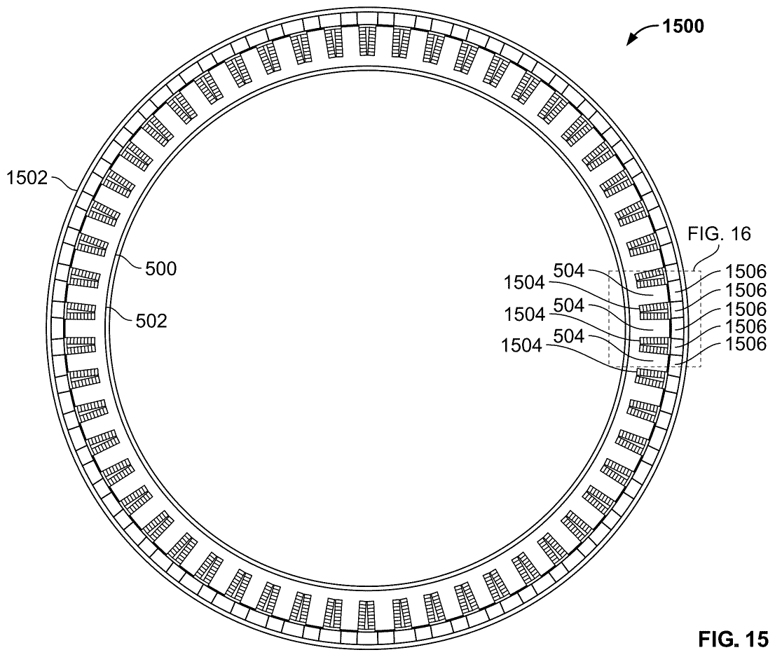

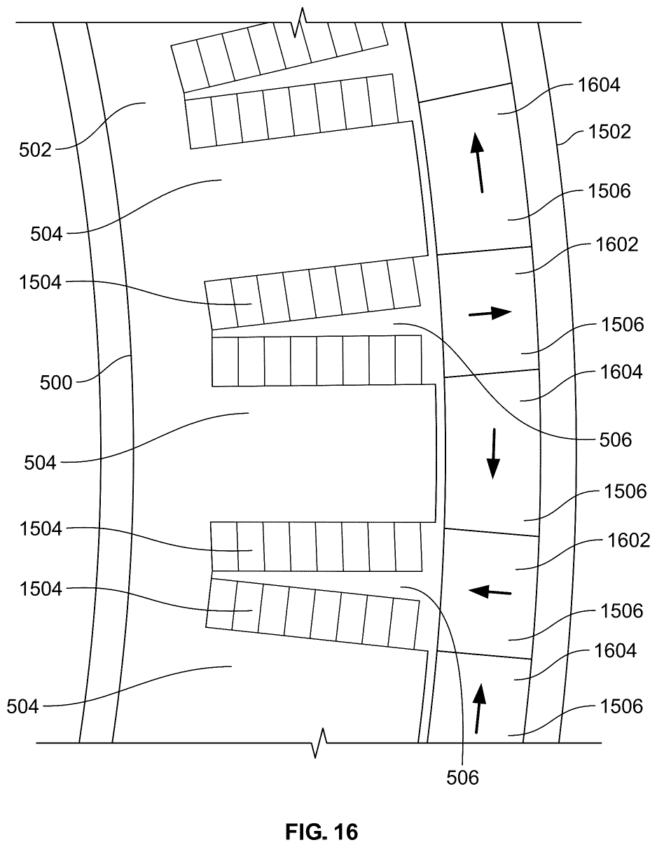

FIG. 15 is a side cross-sectional view of an example electric machine 1500 including the stator 500 of FIG. 5 and an example rotor 1502. FIG. 16 is an enlarged view of a portion of FIG. 15. In the illustrated example of FIGS. 15 and 16, the stator 500 includes a plurality of example edgewise coils 1504, wherein respective ones of the edgewise coils 1504 have been radially loaded onto corresponding respective ones of the teeth 504 of the stator 500. In some examples, one or more layer(s) of insulation (e.g., slot liners) is/are located and/or positioned between the respective ones of the edgewise coils 1504 and the respective ones of the teeth 504 in connection with the edgewise coils 1504 being radially loaded onto the teeth 504, as generally described above in the examples of FIGS. 8-10. In some examples, the edgewise coils 1504 of FIGS. 15 and 16 can correspond to and/or be implemented by the edgewise coils 1102 of FIG. 11 described above, wherein respective ones of the edgewise coils 1102 are connected to one another by corresponding respective ones of the interconnect members 1104 of FIG. 11. In other examples, the edgewise coils 1504 of FIGS. 15 and 16 can instead correspond to and/or be implemented by the first edgewise coils 1202 and the second edgewise coils 1204 of FIG. 12 described above, wherein respective ones of the first edgewise coils 1202 are connected to respective ones of the second edgewise coils 1204 via corresponding respective ones of the extension arms 1206 of FIG. 12. In still other examples, the edgewise coils 1504 of FIGS. 15 and 16 can instead correspond to and/or be implemented by the edgewise coils 1302 of FIG. 13 described above, wherein respective ones of the edgewise coils 1302 are formed by the single wire 1304 (e.g., a continuous, one-piece wire) of FIG. 13.

The rotor 1502 of FIG. 15 is positioned and/or located externally relative to the stator 500 such that the rotor 1502 circumscribes the stator 500. The rotor 1502 is configured to move (e.g., rotate) relative to the stator 500, which remains stationary. In the illustrated example of FIGS. 15 and 16, the rotor 1502 includes a plurality of example permanent magnets 1506 arranged in a Halbach array. The Halbach array augments the magnetic field on one side of the array of the permanent magnets 1506 while cancelling the magnetic field on the other side of the array of permanent magnets 1506 to near zero. This effect is achieved by implementing a spatially rotating pattern of magnetization progressing along neighboring sequential ones of the permanent magnets 1506 according to the following pattern: (1) north pole facing circumferentially leftward; (2) north pole facing radially outward; (3) north pole facing circumferentially rightward; and (4) north pole facing radially inward, as generally indicated in FIG. 16. Arranging the permanent magnets 1506 of the rotor 1502 in a Halbach array eliminates the need for a laminated magnetic steel structure (e.g., a back iron) that would otherwise be required to concentrate the magnetic flux associated with the rotor 1502 toward the air gap of the electric machine 1500. Eliminating the back iron from the rotor 1502 advantageously reduces the overall system mass, reduces wheel inertia, increases air gap flux density, and increases gravimetric torque density, thereby positively influencing the overall performance of the electric machine 1500. Eliminating the back iron from the rotor 1502 also advantageously increases (e.g., maximizes) a diameter of an air gap formed between the stator 500 and the rotor 1502 of the electric machine 1500, which in turn advantageously increases the volumetric torque density associated with the electric machine 1500. As a result, the electric machine 1500 of FIGS. 15 and 16 is advantageously able to produce more torque in the package space (e.g., the overall volume of the machine) of the electric machine 1500 in comparison to the torque which might be produced in the similarly-sized (e.g., identically-sized) package space (e.g., the overall volume of the machine) of a conventional electric machine.

The aforementioned configuration of the Halbach array of the permanent magnets 1506 of FIGS. 15 and 16 results in the formation of two radially-oriented magnetic poles for each sequence of four respective ones of the permanent magnets 1506. In the illustrated example of FIGS. 15 and 16, the configuration and/or construction of the Halbach array includes alternating ones of the permanent magnets 1506 of rectangular and trapezoidal cross-sectional shapes, thereby allowing the permanent magnets 1506 to be inserted radially or axially into and/or onto the rotor 1502. For example, as shown in FIG. 16, example rectangular cross-sectioned radially magnetized segments 1602 from among the permanent magnets 1506 can be rotated in the axial direction of the electric machine 1500 to achieve inwards and outwards directions of magnetization. Conversely, example trapezoidal cross-sectioned circumferentially magnetized segments 1604 from among the permanent magnets 1506 can be rotated in a radial plane from the center line of the electric machine 1500 to achieve the two required tangential directions of magnetization. This arrangement enables the Halbach array to be constructed from just two magnet cross-sections. In this regard, a pair of magnet poles covers three hundred and sixty electrical degrees (360°), meaning that a single magnet pole covers one hundred and eighty electrical degrees (180°). In the illustrated example of FIGS. 15 and 16, the smaller radially magnetized pole magnets 1602 take up thirty-nine to forty-seven percent (39% -47%) of the arc of the electric machine 1500, and the larger Halbach tangential magnetized pole magnets 1604 take up the remaining fifty-three to sixty-one percent (53% -61%) of the arc of the electric machine 1500. The aforementioned ratio advantageously achieves the highest amount of torque density for the electric machine 1500 of FIGS. 15 and 16. In other examples, different ratios may instead be preferable.

As shown in FIGS. 15 and 16, the rotor 1502 includes a total of one hundred and four permanent magnets 1506 arranged in the aforementioned Halbach array, thereby resulting in a total of fifty-two radially-oriented magnetic poles. As discussed above in connection with FIGS. 5 and 6, the stator 500 includes a total of fifty-four teeth 504 and a corresponding total of fifty-four slots 506. The electric machine 1500 of FIGS. 15 and 16 accordingly has a slot pole combination of fifty-four slots and fifty-two poles. In other examples, different slot pole combinations may instead be preferable.

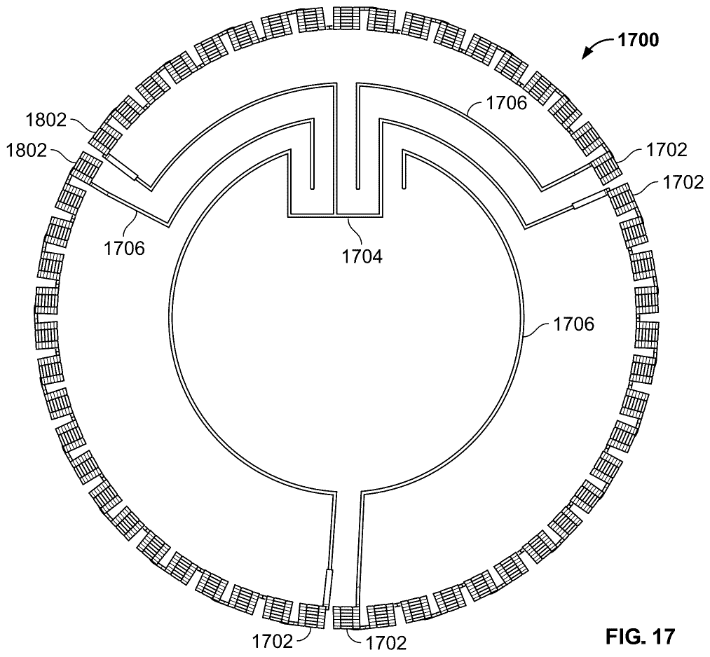

The ends of each belt of the edgewise coils 1504 of the electric machine 1500 of FIGS. 15 and 16 can be connected in a star wiring configuration, either internally or externally of the electric machine 1500. For example, FIG. 17 illustrates a plurality of example edgewise coils 1702 arranged in an example star wiring configuration 1700 for use with the electric machine 1500 of FIGS. 15 and 16. As shown in FIG. 17, the star wiring configuration 1700 is a four-wire, three-phase wiring arrangement in which the starting ends of each belt of the edgewise coils 1702 are connected together to form a neutral or star point (e.g., an example neutral wire 1704). In addition to the neutral wire 1704, the star wiring configuration 1700 further includes three example phase wires 1706, with each phase wire 1706 being connected to the finishing end of a belt of the edgewise coils 1702, as shown in FIG. 17. In some examples, the edgewise coils 1702 of FIG. 17 can correspond to and/or be implemented by the edgewise coils 1102 of FIG. 11 described above, wherein respective ones of the edgewise coils 1102 are connected to one another by corresponding respective ones of the interconnect members 1104 of FIG. 11. In other examples, the edgewise coils 1702 of FIG. 17 can instead correspond to and/or be implemented by the first edgewise coils 1202 and the second edgewise coils 1204 of FIG. 12 described above, wherein respective ones of the first edgewise coils 1202 are connected to respective ones of the second edgewise coils 1204 via corresponding respective ones of the extension arms 1206 of FIG. 12. In still other examples, the edgewise coils 1702 of FIG. 17 can instead correspond to and/or be implemented by the edgewise coils 1302 of FIG. 13 described above, wherein respective ones of the edgewise coils 1302 are formed by the single wire 1304 (e.g., a continuous, one-piece wire) of FIG. 13.

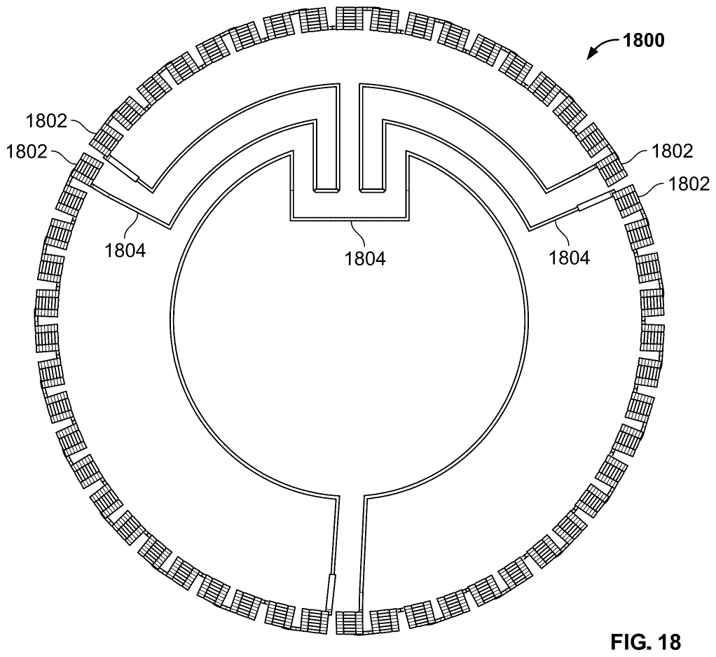

The ends of each belt of the edgewise coils 1504 of the electric machine 1500 of FIGS. 15 and 16 can alternatively be connected in a delta wiring configuration, either internally or externally of the electric machine 1500. For example, FIG. 18 illustrates a plurality of example edgewise coils 1802 arranged in an example delta wiring configuration 1800 for use with the electric machine 1500 of FIGS. 15 and 16. As shown in FIG. 18, the delta wiring configuration 1800 is a three-wire, three-phase wiring arrangement in which the starting end of each one of the belts of the edgewise coils 1802 is connected to a finishing end of a different one of the belts of the edgewise coils 1802 via one of three example phase wires 1804. In some examples, the edgewise coils 1802 of FIG. 18 can correspond to and/or be implemented by the edgewise coils 1102 of FIG. 11 described above, wherein respective ones of the edgewise coils 1102 are connected to one another by corresponding respective ones of the interconnect members 1104 of FIG. 11. In other examples, the edgewise coils 1802 of FIG. 18 can instead correspond to and/or be implemented by the first edgewise coils 1202 and the second edgewise coils 1204 of FIG. 12 described above, wherein respective ones of the first edgewise coils 1202 are connected to respective ones of the second edgewise coils 1204 via corresponding respective ones of the extension arms 1206 of FIG. 12. In still other examples, the edgewise coils 1802 of FIG. 18 can instead correspond to and/or be implemented by the edgewise coils 1302 of FIG. 13 described above, wherein respective ones of the edgewise coils 1302 are formed by the single wire 1304 (e.g., a continuous, one-piece wire) of FIG. 13.

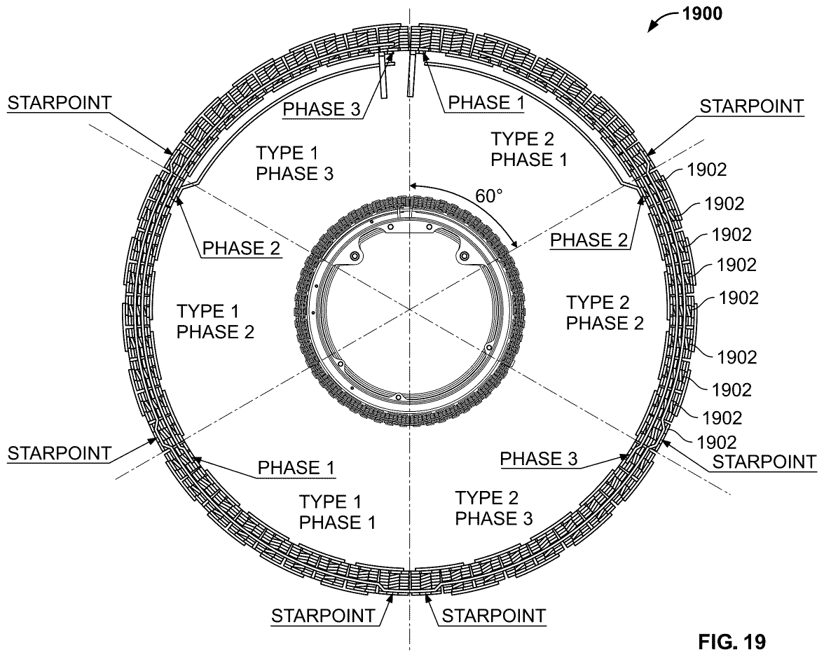

FIG. 19 illustrates a plurality of example edgewise coils 1902 arranged in another example star wiring configuration 1900 for use with the electric machine 1500 of FIGS. 15 and 16. As shown in FIG. 19, two belts of nine slots per phase (e.g., nine edgewise coils 1902 per phase) are implemented, with each belt having three phases. The winding configuration of FIG. 19 accordingly results in an electric motor having a total of fifty-four slots (e.g., 2 belts×3 phases×9 slots=54 slots). As further shown in FIG. 19, respective ones of a plurality of star point connections (e.g., neutral connections) for the belts of the electric machine are made along the outer circumference (e.g., the outer radius) of the belts, and respective ones of a plurality of phase connections for the belts are made along the inner circumference (e.g., the inner radius) of the belts. These features are advantageous both for packaging and for part count. In the illustrated example of FIG. 19, the edgewise coils 1902 of FIG. 19 correspond to and/or are implemented by the edgewise coils 1102 of FIG. 11 described above, wherein respective ones of the edgewise coils 1102 are connected to one another by corresponding respective ones of the interconnect members 1104 of FIG. 11. In other examples, the edgewise coils 1902 of FIG. 19 can instead correspond to and/or be implemented by the first edgewise coils 1202 and the second edgewise coils 1204 of FIG. 12 described above, wherein respective ones of the first edgewise coils 1202 are connected to respective ones of the second edgewise coils 1204 via corresponding respective ones of the extension arms 1206 of FIG. 12. In still other examples, the edgewise coils 1902 of FIG. 19 can instead correspond to and/or be implemented by the edgewise coils 1302 of FIG. 13 described above, wherein respective ones of the edgewise coils 1302 are formed by the single wire 1304 (e.g., a continuous, one-piece wire) of FIG. 13.

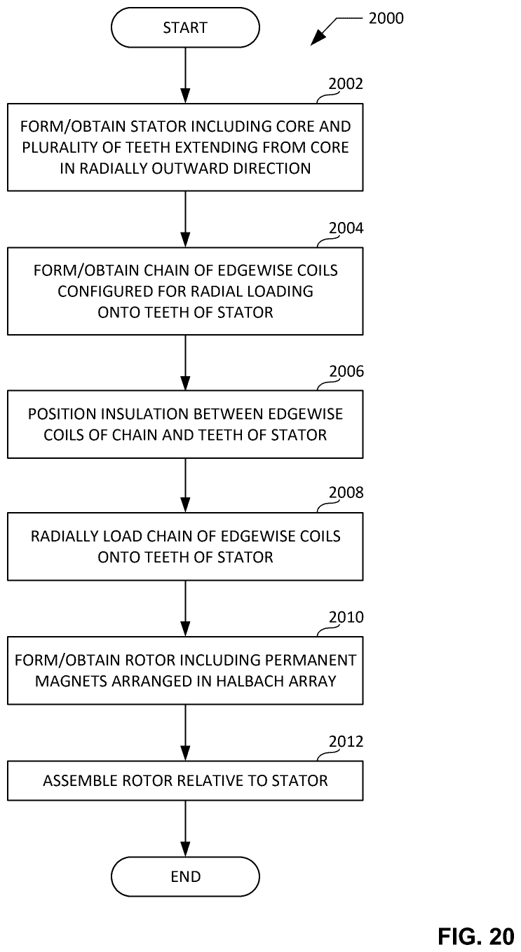

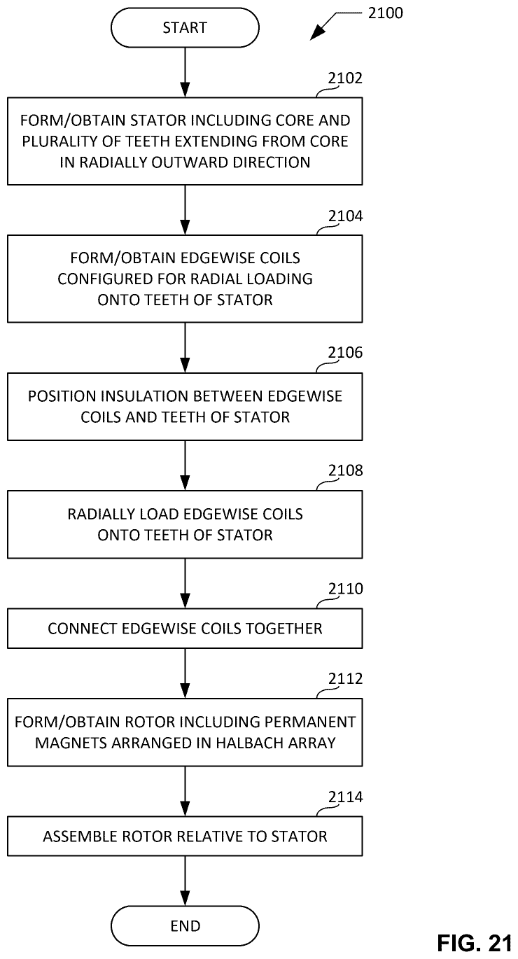

FIGS. 20 and 21 provide flowcharts corresponding to methods and/or processes associated with assembling the electric machines disclosed herein. The numbered blocks of the illustrated flowcharts represent operations and/or steps that are performed in the course of performing the described methods and/or processes. While the numbered blocks of the illustrated flowcharts are shown and described in a particular sequence and/or order, in other examples the numbered blocks of the flowcharts can instead be arranged in a different sequence and/or order. In still other examples, one or more of the numbered blocks illustrated in the flowcharts of FIGS. 20 and 21 can instead be omitted or modified, or one or more numbered blocks not presently shown in the flowcharts of FIGS. 20 and 21 can be added.

FIG. 20 is a flowchart representing a first example method 2000 for assembling an electric machine (e.g., an electric motor). In some examples, all of the numbered blocks shown in the flowchart of FIG. 20 are performed manually (e.g., by one or more humans). In other examples, one or more of the numbered blocks shown in the flowchart of FIG. 20 can instead be performed by and/or with assistance from a machine (e.g., a robotic assisted operation). In still other examples, all of the numbered blocks shown in the flowchart of FIG. 20 can instead be performed in a fully-automated manner (e.g., via a computer-controlled assembly line) without human interaction and/or guidance. The method 2000 of FIG. 20 begins at Block 2002. At Block 2002, a stator is formed and/or obtained, wherein the stator includes a ferromagnetic core and a plurality of teeth extending from the ferromagnetic core in a radially outward direction. For example, Block 2002 can be performed by forming and/or obtaining the stator 500 of FIG. 5 which includes the ferromagnetic core 502 and the plurality of teeth 504 described above. Following Block 2002, the method 2000 of FIG. 20 proceeds to Block 2004.

At Block 2004, a chain of edgewise coils is formed and/or obtained, wherein the edgewise coils are configured for radial loading onto the teeth of the stator. For example, Block 2004 can be performed by forming and/or obtaining the chain 1114 of edgewise coils 1102 of FIG. 11 in which the edgewise coils 1102 are configured to be radially loaded onto the teeth 504 of the stator 500 of FIG. 5. As another example, Block 2004 can be performed by forming and/or obtaining the chain 1216 of first edgewise coils 1202 and second edgewise coils 1204 of FIG. 12 in which the first edgewise coils 1202 and the second edgewise coils 1204 are configured to be radially loaded onto the teeth 504 of the stator 500 of FIG. 5. As yet another example, Block 2004 can be performed by forming and/or obtaining the chain 1306 of edgewise coils 1302 of FIG. 13 in which the edgewise coils 1302 are configured to be radially loaded onto the teeth 504 of the stator 500 of FIG. 5. Following Block 2004, the method 2000 of FIG. 20 proceeds to Block 2006.

At Block 2006, insulation is positioned between the edgewise coils of the chain and the teeth of the stator. For example, Block 2006 can be performed by coupling and/or otherwise applying (e.g., radially applying) insulation (e.g., the slot liners 802 of FIG. 8) to respective ones of the edgewise coils of the chain, as generally shown in FIG. 8 described above. As another example, Block 2006 can be performed by coupling and/or otherwise applying (e.g., radially or axially applying) insulation (e.g., the slot liners 802 of FIGS. 9 and 10) into respective ones of the slots 506 bounding the respective ones of the teeth 504 of the stator 500, as generally shown in FIGS. 9 and 10 described above. Following Block 2006, the method 2000 of FIG. 20 proceeds to Block 2008.

At Block 2008, the chain of edgewise coils is radially loaded onto the teeth of the stator. For example, Block 2008 can be performed by radially loading the edgewise coils 1102 of the chain 1114 of FIG. 11 onto the teeth 504 of the stator 500 of FIG. 5. As another example, Block 2008 can be performed by radially loading the first edgewise coils 1202 and the second edgewise coils 1204 of the chain 1216 of FIG. 12 onto the teeth 504 of the stator 500 of FIG. 5. As yet another example, Block 2008 can be performed by radially loading the edgewise coils 1302 of the chain 1306 of FIG. 13 onto the teeth 504 of the stator 500 of FIG. 5. Following Block 2008, the method 2000 of FIG. 20 proceeds to Block 2010.

At Block 2010, a rotor is formed and/or obtained, wherein the rotor includes permanent magnets arranged in a Halbach array. For example, Block 2110 can be performed by forming and/or obtaining the rotor 1502 of FIG. 15 which includes the permanent magnets 1506 arranged in a Halbach array, as described above. In some examples, the Halbach array of the rotor 1502 can be pre-formed into Halbach array segments (e.g., four magnets to complete a pole pair) in connection with Block 2010. In some examples, the permanent magnets 1506 that form the Halbach array of the rotor 1502 can be pre-assembled to an inner ferromagnetic ring of the rotor 1502 in connection with Block 2010. In some examples, the rotor 1502 is a composite material rotor that can be formed over a pre-positioned Halbach array in connection with Block 2010. Following Block 2010, the method 2000 of FIG. 20 proceeds to Block 2012.

At Block 2012, the rotor is assembled relative to the stator. For example, Block 2012 can be performed by positioning the rotor 1502 (e.g., including the permanent magnets 1506) externally relative to the stator 500 (e.g., including the radially loaded edgewise coils 1102 of FIG. 11, the radially loaded first and second edgewise coils 1202, 1204 of FIG. 12, or the radially loaded edgewise coils 1302 of FIG. 13) such that the rotor 1502 circumscribes the stator 500, as shown for example in FIG. 15. Following Block 2012, the method 2000 of FIG. 20 ends.

FIG. 21 is a flowchart representing a second example method 2100 for assembling an electric machine (e.g., an electric motor). In some examples, all of the numbered blocks illustrated in the flowchart of FIG. 21 are performed manually (e.g., by one or more humans). In other examples, one or more of the numbered blocks shown in the flowchart of FIG. 21 can instead be performed by and/or with assistance from a machine (e.g., a robotic assisted operation). In still other examples, all of the numbered blocks shown in the flowchart of FIG. 21 can instead be performed in a fully-automated manner (e.g., via a computer-controlled assembly line) without human interaction and/or guidance. The method 2100 of FIG. 21 begins at Block 2102. At Block 2102, a stator is formed and/or obtained, wherein the stator includes a ferromagnetic core and a plurality of teeth extending from the ferromagnetic core in a radially outward direction. For example, Block 2102 can be performed by forming and/or obtaining the stator 500 of FIG. 5 which includes the ferromagnetic core 502 and the plurality of teeth 504 described above. Following Block 2102, the method 2100 of FIG. 21 proceeds to Block 2104.

At Block 2104, edgewise coils are formed and/or obtained, wherein the edgewise coils are configured for radial loading onto the teeth of the stator. For example, Block 2104 can be performed by forming and/or obtaining the edgewise coils 1102 of FIG. 11 in which the edgewise coils 1102 are configured to be radially loaded onto the teeth 504 of the stator 500 of FIG. 5. As another example, Block 2104 can be performed by forming and/or obtaining the first edgewise coils 1202 and the second edgewise coils 1204 of FIG. 12 in which the first edgewise coils 1202 and the second edgewise coils 1204 are configured to be radially loaded onto the teeth 504 of the stator 500 of FIG. 5. Following Block 2104, the method 2100 of FIG. 21 proceeds to Block 2106.

At Block 2106, insulation is positioned between the edgewise coils and the teeth of the stator. For example, Block 2106 can be performed by coupling and/or otherwise applying (e.g., radially applying) insulation (e.g., the slot liners 802 of FIG. 8) to respective ones of the edgewise coils, as generally shown in FIG. 8 described above. As another example, Block 2106 can be performed by coupling and/or otherwise applying (e.g., radially or axially applying) insulation (e.g., the slot liners 802 of FIGS. 9 and 10) into respective ones of the slots 506 bounding the respective ones of the teeth 504 of the stator 500, as generally shown in FIGS. 9 and 10 described above. Following Block 2106, the method 2100 of FIG. 21 proceeds to Block 2108.

At Block 2108, the edgewise coils are radially loaded onto the teeth of the stator. For example, Block 2108 can be performed by radially loading the edgewise coils 1102 of FIG. 11 onto the teeth 504 of the stator 500 of FIG. 5. As another example, Block 2108 can be performed by radially loading the first edgewise coils 1202 and the second edgewise coils 1204 of FIG. 12 onto the teeth 504 of the stator 500 of FIG. 5. Following Block 2108, the method 2100 of FIG. 21 proceeds to Block 2110.

At Block 2110, respective once of the edgewise coils are connected together. For example, Block 2110 can be performed by connecting the respective ones of the radially-loaded edgewise coils 1102 of FIG. 11 together via respective ones of the interconnect members 1104 of FIG. 11. As another example, Block 2110 can be performed by connecting the respective ones of the first and second edgewise coils 1202, 1204 of FIG. 12 together via respective ones of the extension arms 1206 of FIG. 12. Following Block 2110, the method 2100 of FIG. 21 proceeds to Block 2112.

At Block 2112, a rotor is formed and/or obtained, wherein the rotor includes permanent magnets arranged in a Halbach array. For example, Block 2112 can be performed by forming and/or obtaining the rotor 1502 of FIG. 15 which includes the permanent magnets 1506 arranged in a Halbach array, as described above. In some examples, the Halbach array of the rotor 1502 can be pre-formed into Halbach array segments (e.g., four magnets to complete a pole pair) in connection with Block 2112. In some examples, the permanent magnets 1506 that form the Halbach array of the rotor 1502 can be pre-assembled to an inner ferromagnetic ring of the rotor 1502 in connection with Block 2112. In some examples, the rotor 1502 is a composite material rotor that can be formed over a pre-positioned Halbach array in connection with Block 2112. Following Block 2112, the method 2100 of FIG. 21 proceeds to Block 2114.

At Block 2114, the rotor is assembled relative to the stator. For example, Block 2114 can be performed by positioning the rotor 1502 (e.g., including the permanent magnets 1506) externally relative to the stator 500 (e.g., including the radially loaded edgewise coils 1102 of FIG. 11, the radially loaded first and second edgewise coils 1202, 1204 of FIG. 12, or the radially loaded edgewise coils 1302 of FIG. 13) such that the rotor 1502 circumscribes the stator 500, as shown for example in FIG. 15. Following Block 2114, the method 2100 of FIG. 21 ends.

The following paragraphs provide various examples in relation to the disclosed in-wheel electric machines (e.g., electric motors, electric generators, etc.) for electric vehicles.

Example 1 includes an in-wheel electric machine. In Example 1, the in-wheel electric machine includes a stator and a rotor. The stator includes a ferromagnetic core, a plurality of teeth circumferentially arranged about the ferromagnetic core, and a plurality of edgewise coils coupled to the plurality of teeth. Respective ones of the teeth extend in a radially outward direction from the ferromagnetic core and are spaced apart from one another by respective ones of a plurality of slots. Respective ones of the edgewise coils are radially loaded onto the respective ones of the teeth. The rotor is located externally relative to the stator. The rotor includes a plurality of permanent magnets arranged in a Halbach array. The rotor is configured to rotate relative to the stator.

Example 2 includes the in-wheel electric machine of Example 1. In Example 2, each tooth from among the plurality of teeth includes a pair of parallel walls extending in an axial direction of the stator.

Example 3 includes the in-wheel electric machine of Example 2. In Example 3, the parallel walls form a pair of opposed, axially-extending, parallel surfaces configured to enable one of the plurality of edgewise coils to be radially loaded onto one of the plurality of teeth.

Example 4 includes the in-wheel electric machine of Example 1. In Example 4, the stator includes a total of fifty-four teeth and a total of fifty-four slots.

Example 5 includes the in-wheel electric machine of Example 4. In Example 5, the rotor includes a total of fifty-two poles provided by the plurality of permanent magnets. The in-wheel electric machine accordingly has a slot pole combination of fifty-four slots and fifty-two poles.

Example 6 includes the in-wheel electric machine of Example 1. In Example 6, the respective ones of the edgewise coils are coupled to one another.

Example 7 includes the in-wheel electric machine of Example 6. In Example 7, connections between the respective ones of the edgewise coils are formed via respective ones of a plurality of interconnect members. Each one of the interconnect members extends between two of the respective ones of the edgewise coils. Each one of the interconnect members includes a first end configured to be coupled to a connection point of a first one of the edgewise coils, and a second end configured to be coupled to a connection point of a second one of the edgewise coils located adjacent the first one of the edgewise coils.

Example 8 includes the in-wheel electric machine of Example 6. In Example 8, connections between the respective ones of the edgewise coils are formed via respective ones of a plurality of extension arms integrally formed in a first subset of the respective ones of the edgewise coils. A second subset of the respective ones of the edgewise coils do not include the plurality of extension arms. Each one of the edgewise coils from among the first subset of the respective ones of the edgewise coils includes a first extension arm configured to be coupled to a connection point of a first one of the edgewise coils from among the second subset of the respective ones of the edgewise coils, and a second extension arm configured to be coupled to a connection point of a second one of the edgewise coils from among the second subset of the respective ones of the edgewise coils. The one of the edgewise coils from among the first subset of the respective ones of the edgewise coils is located between the first one and the second one of the edgewise coils from among the second subset of the respective ones of the edgewise coils.

Example 9 includes the in-wheel electric machine of Example 6. In Example 9, connections between the respective ones of the edgewise coils are formed subsequent to the respective ones of the edgewise coils being radially loaded onto the respective ones of the teeth.

Example 10 includes the in-wheel electric machine of Example 6. In Example 10, connections between the respective ones of the edgewise coils are formed prior to the respective ones of the edgewise coils being radially loaded onto the respective ones of the teeth.

Example 11 includes the in-wheel electric machine of Example 10. In Example 11, the connections between the respective ones of the edgewise coils result in formation of a chain including the respective ones of the edgewise coils. The chain is configured to be radially loaded onto the respective ones of the teeth subsequent to formation of the chain.

Example 12 includes the in-wheel electric machine of Example 1. In Example 12, the respective ones of the edgewise coils are arranged as a chain formed by a continuous wire. The chain is configured to be radially loaded onto the respective ones of the teeth subsequent to formation of the chain.

Example 13 includes the in-wheel electric machine of Example 1. In Example 13, the in-wheel electric machine further comprises a tire coupled to and located externally relative to the rotor.

Example 14 is an example method for assembling an example in-wheel electric machine. In Example 14, the method includes radially loading respective ones of a plurality of edgewise coils onto respective ones of a plurality of teeth of a stator of the in-wheel electric machine. The stator includes a ferromagnetic core. The respective ones of the teeth are circumferentially arranged about the ferromagnetic core. The respective ones of the teeth extend in a radially outward direction from the ferromagnetic core and are spaced apart from one another by respective ones of a plurality of slots. In Example 14, the method further includes locating a rotor of the in-wheel electric machine externally relative to the stator. The rotor includes a plurality of permanent magnets arranged in a Halbach array. The rotor is configured to rotate relative to the stator.

Example 15 includes the method of Example 14. In Example 15, each tooth from among the plurality of teeth includes a pair of parallel walls extending in an axial direction of the stator. The parallel walls form a pair of opposed, axially-extending, parallel surfaces configured to enable one of the plurality of edgewise coils to be radially loaded onto one of the plurality of teeth.

Example 16 includes the method of Example 14. In Example 14, the method further includes coupling the respective ones of the edgewise coils to one another.

Example 17 includes the method of Example 16. In Example 17, connections between the respective ones of the edgewise coils are formed subsequent to the respective ones of the edgewise coils being radially loaded onto the respective ones of the teeth.

Example 18 includes the method of Example 16. In Example 18, connections between the respective ones of the edgewise coils are formed prior to the respective ones of the edgewise coils being radially loaded onto the respective ones of the teeth.

Example 19 includes the method of Example 18. In Example 19, the connections between the respective ones of the edgewise coils result in formation of a chain including the respective ones of the edgewise coils. The chain is configured to be radially loaded onto the respective ones of the teeth subsequent to the formation of the chain.

Example 20 includes the method of Example 18. In Example 20, the respective ones of the edgewise coils are arranged as a chain formed by a continuous wire. The chain is configured to be radially loaded onto the respective ones of the teeth subsequent to the formation of the chain.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An in-wheel electric machine, comprising:
a stator including:
a ferromagnetic core;
a plurality of teeth circumferentially arranged about the ferromagnetic core, respective ones of the teeth extending in a radially outward direction from the ferromagnetic core and being spaced apart from one another by respective ones of a plurality of slots; and
a plurality of edgewise coils coupled to the plurality of teeth, respective ones of the edgewise coils being radially loaded onto the respective ones of the teeth; and
a rotor located externally relative to the stator, the rotor including a plurality of permanent magnets arranged in a Halbach array, the rotor configured to rotate relative to the stator.

2. The in-wheel electric machine of claim 1, wherein each tooth from among the plurality of teeth includes a pair of parallel walls extending in an axial direction of the stator.

3. The in-wheel electric machine of claim 2, wherein the parallel walls form a pair of opposed, axially-extending, parallel surfaces configured to enable one of the plurality of edgewise coils to be radially loaded onto one of the plurality of teeth.

4. The in-wheel electric machine of claim 1, wherein the stator includes a total of fifty-four teeth and a total of fifty-four slots.

5. The in-wheel electric machine of claim 4, wherein the rotor includes a total of fifty-two poles provided by the plurality of permanent magnets, wherein the in-wheel electric machine accordingly has a slot pole combination of fifty-four slots and fifty-two poles.

6. The in-wheel electric machine of claim 1, wherein the respective ones of the edgewise coils are coupled to one another.

7. The in-wheel electric machine of claim 6, wherein connections between the respective ones of the edgewise coils are formed via respective ones of a plurality of interconnect members, wherein each one of the interconnect members extends between two of the respective ones of the edgewise coils, wherein each one of the interconnect members includes a first end configured to be coupled to a connection point of a first one of the edgewise coils and a second end configured to be coupled to a connection point of a second one of the edgewise coils located adjacent the first one of the edgewise coils.

8. The in-wheel electric machine of claim 6, wherein connections between the respective ones of the edgewise coils are formed via respective ones of a plurality of extension arms integrally formed in a first subset of the respective ones of the edgewise coils, wherein a second subset of the respective ones of the edgewise coils do not include the plurality of extension arms, wherein each one of the edgewise coils from among the first subset of the respective ones of the edgewise coils includes a first extension arm configured to be coupled to a connection point of a first one of the edgewise coils from among the second subset of the respective ones of the edgewise coils and a second extension arm configured to be coupled to a connection point of a second one of the edgewise coils from among the second subset of the respective ones of the edgewise coils, wherein the one of the edgewise coils from among the first subset of the respective ones of the edgewise coils is located between the first one and the second one of the edgewise coils from among the second subset of the respective ones of the edgewise coils.

9. The in-wheel electric machine of claim 6, wherein connections between the respective ones of the edgewise coils are formed subsequent to the respective ones of the edgewise coils being radially loaded onto the respective ones of the teeth.

10. The in-wheel electric machine of claim 6, wherein connections between the respective ones of the edgewise coils are formed prior to the respective ones of the edgewise coils being radially loaded onto the respective ones of the teeth.

11. The in-wheel electric machine of claim 10, wherein the connections between the respective ones of the edgewise coils result in formation of a chain including the respective ones of the edgewise coils, wherein the chain is configured to be radially loaded onto the respective ones of the teeth subsequent to formation of the chain.

12. The in-wheel electric machine of claim 1, wherein the respective ones of the edgewise coils are arranged as a chain formed by a continuous wire, wherein the chain is configured to be radially loaded onto the respective ones of the teeth subsequent to formation of the chain.

13. The in-wheel electric machine of claim 1, further comprising a tire coupled to and located externally relative to the rotor.

14. A method for assembling an in-wheel electric machine, the method comprising:
radially loading respective ones of a plurality of edgewise coils onto respective ones of a plurality of teeth of a stator of the in-wheel electric machine, the stator including a ferromagnetic core, the respective ones of the teeth circumferentially arranged about the ferromagnetic core, the respective ones of the teeth extending in a radially outward direction from the ferromagnetic core and being spaced apart from one another by respective ones of a plurality of slots; and
locating a rotor of the in-wheel electric machine externally relative to the stator, the rotor including a plurality of permanent magnets arranged in a Halbach array, the rotor configured to rotate relative to the stator.

15. The method of claim 14, wherein each tooth from among the plurality of teeth includes a pair of parallel walls extending in an axial direction of the stator, the parallel walls forming a pair of opposed, axially-extending, parallel surfaces configured to enable one of the plurality of edgewise coils to be radially loaded onto one of the plurality of teeth.

16. The method of claim 14, further comprising coupling the respective ones of the edgewise coils to one another.

17. The method of claim 16, wherein connections between the respective ones of the edgewise coils are formed subsequent to the respective ones of the edgewise coils being radially loaded onto the respective ones of the teeth.

18. The method of claim 16, wherein connections between the respective ones of the edgewise coils are formed prior to the respective ones of the edgewise coils being radially loaded onto the respective ones of the teeth.

19. The method of claim 18, wherein the connections between the respective ones of the edgewise coils result in formation of a chain including the respective ones of the edgewise coils, wherein the chain is configured to be radially loaded onto the respective ones of the teeth subsequent to formation of the chain.

20. The method of claim 14, wherein the respective ones of the edgewise coils are arranged as a chain formed by a continuous wire, wherein the chain is configured to be radially loaded onto the respective ones of the teeth subsequent to formation of the chain.
